(19) United States
(12) Patent Application Publication
(10) Pub. No.: US 2025/0145257 A1
(43) Pub. Date: May 8, 2025

(54) NAVIGATION SUPPORTING DEVICE, NAVIGATION SUPPORTING SYSTEM, NAVIGATION SUPPORTING METHOD, AND COMPUTER READABLE MEDIUM

(71) Applicant: Furuno Electric Co., Ltd., Nishinomiya (JP)

(72) Inventor: Kazuya KISHIMOTO, Nishinomiya (JP)

(21) Appl. No.: 19/017,140

(22) Filed: Jan. 10, 2025

Related U.S. Application Data
(63) Continuation-in-part of application No. PCT/JP2023/029932, filed on Aug. 21, 2023.

(30) Foreign Application Priority Data
Sep. 15, 2022 (JP) 2022-146877

(51) Int. Cl. B63B 49/00; B63B 79/40; G01S 17/42; G01S 17/89; G01S 17/93

(52) U.S. Cl. CPC B63B 49/00; B63B 79/40; G01S 17/42; G01S 17/89; G01S 17/93

(57) ABSTRACT

The navigation supporting device is provided with processing circuitry configured to: generate a plurality of candidate line segments for constituting a target based on point cloud data including a plurality of point clouds obtained by detecting surroundings of a ship. Based on a positional relationship between the ship and the plurality of candidate line segments, the processing circuitry selects an estimated line segment constituting the target from the plurality of candidate line segments. Further, the processing circuitry estimates the shape of the target based on the selected estimated line segment.

### CROSS-REFERENCE TO RELATED APPLICATION

The present application is a continuation-in-part of PCT/JP2023/029932, filed on Aug. 21, 2023, and is related to and claims priority from Japanese patent application no. 2022-146877, filed on Sep. 15, 2022. The entire contents of the aforementioned application are hereby incorporated by reference herein.

### TECHNICAL FIELD

The present invention relates to a technique for estimating a specific target involved in a navigation of a ship, such as a pier where the ship docks.

### BACKGROUND

A conventional berthing support devices calculate a distance from a ship to a quay and estimates whether the quay is suitable for berthing from the result.

### SUMMARY

However, a shape of a quay or pier cannot be estimated with good accuracy by a conventional technology.

Therefore, the purpose of the present invention is to estimate with high accuracy the specific object related to the navigation of a ship such as the quay or pier.

The navigation supporting device of this invention is provided with processing circuitry. The processing circuitry generates a plurality of candidate line segments for constituting a target based on point cloud data including a plurality of point clouds obtained by detecting surroundings of a ship. The processing circuitry selects an estimated line segment constituting the target from the plurality of candidate line segments based on a positional relationship between the ship and the plurality of candidate line segments. The shape estimating unit estimates the shape of the target based on the selected estimated line segment.

In this configuration, the plurality of candidate line segments are calculated for targets around the ship including the target. Since, the estimated line segment is selected from the positional relationship between the plurality of candidate line segments and the ship, the estimated line segment is more likely to be based on the target. Therefore, the navigation supporting device may estimate the target (for example, piers where ships dock) with high accuracy.

In the navigation supporting device of the present invention, the processing circuitry acquires a heading of the ship and selects the estimated line segment based on the heading and an extending direction of the plurality of candidate line segments.

In this configuration, the selecting accuracy of the estimated line segment is improved by basing an orientation of the ship and an orientation of the plurality of candidate line segments.

In the navigation supporting device of this invention, the processing circuitry selects estimated line segment based on an argument between the extending direction of the plurality of candidate line segments and the heading or a direction perpendicular to the heading.

In this configuration, the selecting accuracy of estimated line segment is improved based on the argument.

In the navigation supporting device of the present invention, the processing circuitry selects the estimated line segment based on a distance between a position of the ship and the plurality of candidate line segments.

In this configuration, the selecting accuracy of estimated line segment is improved based on the distance.

In the navigation supporting device of the present invention, based on a relationship between the heading and the extending direction of the plurality of candidate line segments, the processing circuitry classifies the plurality of candidate line segments into a plurality of areas with respect to the position of the ship. The processing circuitry selects the estimated line segment for each of the plurality of areas.

In this configuration, the selecting accuracy of the estimated line segment is improved by classifying the plurality of candidate line segments according to their position with respect to the ship and then selecting the estimated line segment.

In the navigation supporting device of this invention, the processing circuitry performs classifying based on a cross product of the heading and the extending direction of the plurality of candidate line segment.

In this configuration, classifying may be realized with simple processing.

In the navigation supporting device of the present invention, the processing circuitry sets the plurality of areas to at least the port and starboard sides of the ship.

In this configuration, the estimated line segment constituting at least a lateral target of the ship may be selected with high precision.

In the navigation supporting device of the present invention, the processing circuitry classifies the plurality of candidate line segments into different areas with respect to the position of the ship based on a relationship between the direction perpendicular to the heading and the extending direction of the plurality of candidate line segments.

In this configuration, the selecting accuracy of the estimated line segment is improved by classifying the plurality of candidate line segments according to their position with respect to the ship and then selecting the estimated line segment.

In the navigation supporting device of this invention, the processing circuitry performs classifying based on the cross product of the direction perpendicular to the heading and the direction in which the plurality of candidate line segments extends.

In this configuration, classifying may be achieved with simple processing.

In the navigation supporting of the present invention, the processing circuitry sets the plurality of areas to include at least the area on the bow side.

In this configuration, the estimated line segment constituting at least the target on the bow side of the ship may be selected with high precision. Then, by matching the estimated line segment constituting the target on the side of the ship with the estimated line segment constituting the target on the bow side, the estimated line segment constituting the target on the three sides of the ship may be selected with high precision.

In the navigation supporting device of the present invention, the processing circuitry estimates the shape of the target i.e., a target object based on a connected state of a plurality of estimated line segments.

In this configuration, the shape of the target may be estimated with high accuracy by using the connected state.

In the navigation supporting device of this invention, the processing circuitry estimates the shape of the target based on three estimated line segments that are nearly perpendicular to each other as the connected state.

In this configuration, the shape of the target object that surrounds three sides of the ship may be estimated with high accuracy.

In the navigation supporting device of this invention, the processing circuitry estimates the shape of the target object that has a pier in three directions with the position of the ship as a reference.

In this configuration, the shape of the target object that has a pier in three directions may be estimated with high accuracy.

In the navigation supporting device of the present invention, the processing circuitry extracts a linear component from two-dimensional point cloud data to generate the plurality of candidate line segments.

In this configuration, the plurality of candidate line segments may be generated with high accuracy from the point cloud data.

In the navigation supporting device of the present invention, the processing circuitry performs three-dimensional ranging around the ship to generate three-dimensional point cloud data. The processing circuitry generates two-dimensional point cloud data by projecting three-dimensional point cloud data on a horizontal plane, and outputs the two-dimensional point cloud data.

In this configuration, the point cloud data may be generated with high precision to generate a plurality of candidate line segments including an estimated line segment representing the target.

In the navigation supporting device of the present invention, based on the shape of the target, the processing circuitry performs automatic maneuvering control to bring the ship to a specific position of the target.

In this configuration, since the target is estimated with high precision, the ship may be brought to a specific position with high precision.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a functional block diagram of a navigation supporting device according to an embodiment of the present invention;

FIG. 2 is a functional block diagram of a point cloud generating unit according to an embodiment of the present invention;

FIG. 3 is a plan view showing a target quay;

FIG. 4 is a view showing point cloud data;

FIG. 5 shows the generation state of candidate line segments;

FIG. 6 is a functional block diagram showing an example of a selecting unit according

to an embodiment of the present invention;

FIGS. 7(A), 7(B), and 7(C) illustrate the classifying concept of a plurality of candidate line segments;

FIG. 8 shows an estimated line segment;

FIG. 9 is a functional block diagram showing an example of a shape estimating unit according to an embodiment of the present invention;

FIG. 10 is a diagram illustrating the shape estimation concept;

FIG. 11 is a flow chart showing an example of the navigation supporting method according to the embodiment of the present invention; and

FIG. 12 is a functional block diagram of the navigation supporting system according to the embodiment of the present invention.

### DESCRIPTION OF EMBODIMENTS

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

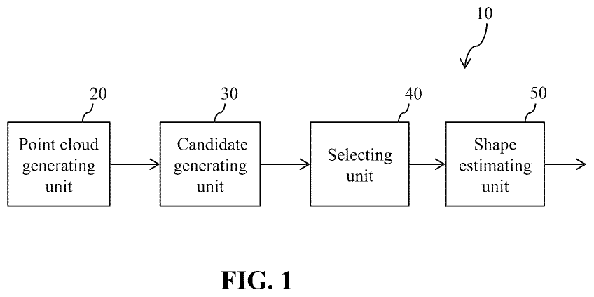

The navigation supporting technology of the embodiment of the present invention will be described with reference to the figures. FIG. 1 is a functional block diagram of the navigation supporting device according to an embodiment of the present invention.

(Schematic configuration of the navigation supporting device 10) As shown in FIG. 1, the navigation supporting device 10 includes a point cloud generating unit 20, a candidate generating unit 30, a selecting unit 40, and a shape estimating unit 50.

Broadly speaking, the point cloud generating unit 20 generates two-dimensional point cloud data by performing three-dimensional ranging of an area including target objects of estimation around the ship. The point cloud generating unit 20 may perform two-dimensional ranging and generate two-dimensional point cloud data. The point cloud data is a collection of multiple range-measured points and comprises coordinate information of each point. For example, the point cloud generating unit 20 measures the range including a jetty (i.e., a pier), which is a target, and generates point cloud data including detection points of the jetty. The point cloud generating unit 20 outputs the point cloud data to the candidate generating unit 30.

Based on the point cloud data, the candidate generating unit 30 generates a plurality of candidate line segments for constituting the target. For example, the candidate generating unit 30 generates a plurality of line segments (linear elements of finite distance) from a plurality of points including the detection points of the pier as candidate line segments. The candidate generating unit 30 outputs the generated plurality of candidate line segments to the selecting unit 40.

The selecting unit 40 selects a plurality of estimated line segments constituting the target from the plurality of candidate line segments based on a positional relationship between the ship and the plurality of candidate line segments. For example, the selecting unit 40 selects the plurality of candidate line segments representing the shape of the pier from the plurality of candidate line segments and makes them the plurality of estimated line segments. The selecting unit 40 outputs the plurality of estimated line segments to the shape estimating unit 50.

The shape estimating unit 50 estimates the shape of the target based on the plurality of estimated line segments. For example, the shape estimating unit 50 estimates the shape of the pier by combining the plurality of estimated line segments representing the shape of the pier.

In this way, the navigation supporting device 10 estimates the shape of the target. At this time, the navigation supporting device 10 calculates the plurality of candidate line segments forming the shape of the target from targets around the ship including the target. Further, the navigation supporting device 10 selects the most probable plurality of estimated line segments forming the shape of the target from the positional relationship between the plurality of candidate line segments and the ship. Thus, the plurality of estimated line segments are more likely to be based on the target. Therefore, the navigation supporting device 10 may estimate the target (For example, piers where ships dock.) with high accuracy.

(Examples of specific configurations of navigation supporting device 10) Next, a specific configuration example of the navigation supporting device 10 will be described. In the following, the case of a jetty formed by a combination of a U-shaped jetty, in other words, two jetties nearly parallel to each other, and a single jetty nearly perpendicular to these two jetties and connected to the ends of these two jetties will be described. It should be noted that the target is not limited to piers of this shape, but may be other shapes of piers or other objects related to vessel navigation, including pier landings, and so on.

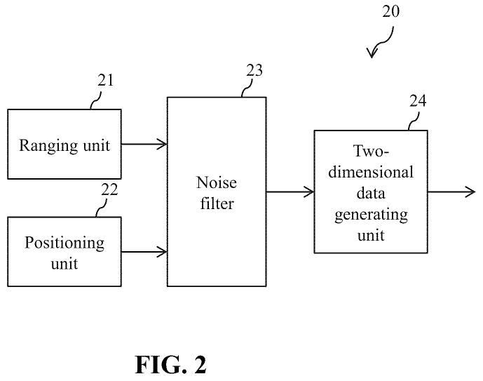

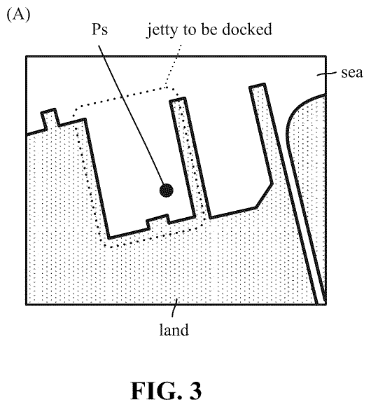

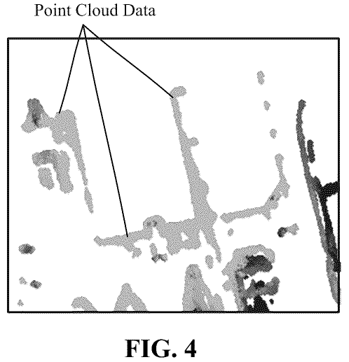

(Point Cloud Generation Unit 20) FIG. 2 is a functional block diagram of the point cloud generating unit 20 according to an embodiment of the present invention. FIG. 3 is a plan view showing the target quay. FIG. 4 is a view showing the point cloud data.

As shown in FIG. 2, the point cloud generating unit 20 includes a ranging unit 21, a positioning unit 22, a noise filter 23, and a two-dimensional data generating unit 24. The noise filter 23 and the two-dimensional data generating unit 24 are realized by, for example, an arithmetic unit.

The ranging unit 21 is equipped with, for example, a LiDAR. The ranging unit 21 detects a plurality of feature points based on the reflected light of a ranging signal (light) transmitted around the ship. The ranging unit 21 detects the distance and three-dimensional orientation of the plurality of feature points with the ship position as a reference. The ranging unit 21 may further use image processing using image data captured by a stereo camera, millimeter-wave radar, etc.

The positioning unit 22 measures the position of the ship. Specifically, the positioning unit 22 measures the position Ps (see FIG. 3) of the ship moored at the jetty. For example, the positioning unit 22 receives a Global Navigation Satellite System (GNSS) signal and performs three-dimensional positioning unit using the received GNSS signal.

The noise filter 23 filters the plurality of feature points. Specifically, the noise filter 23 performs down sampling for a plurality of feature points. The noise filter 23 calculates the three-dimensional coordinates of the plurality of feature points based on the ranging results and the positioning results. The noise filter 23 specifies an extraction range set based on the position of the ship, and removes non-specified feature points. For example, a sea level is set based on the coordinates of a height, and the sea level is designated outside the extraction range. Also, the prescribed range including the pier is specified as the extraction range based on the position of the ship.

Furthermore, the noise filter 23 removes the feature points corresponding to the radius outliers and statistical outliers.

By performing these processes, the navigation supporting device 10 may remove feature points that are less effective for estimating the shape of the pier before generating candidate line segments, thereby reducing the processing load while suppressing the decrease in estimation accuracy.

The two-dimensional data generating unit 24 projects the plurality of feature points of three-dimensional coordinates (points represented in space) on a horizontal plane (converts them into points on a bird's eye view) to generate a plurality of feature points of two-dimensional coordinates, and generate point cloud data.

By such processing, the point cloud data including feature points forming the shape of the jetty as shown in FIG. 4 is generated for the jetty as shown in FIG. 3.

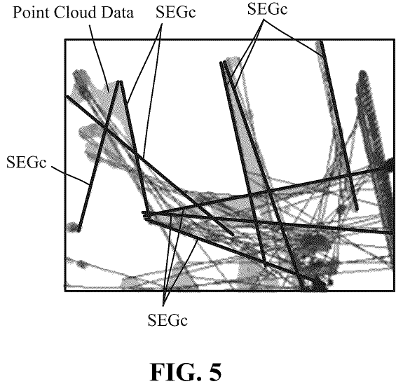

(Candidate generation unit 30) FIG. 5 shows the generation state of candidate lines.

The candidate generating unit 30 is realized by, for example, an arithmetic processing unit. The candidate generating unit 30 generates the plurality of candidate line segments SEGc, which are linear elements of finite distance, for the plurality of feature points constituting the point cloud data, for example, by adopting Hough transform (see FIG. 5).

Through such processing, the plurality of candidate line segments SEGc, including lines forming the shape of the pier, are generated, as shown in FIG. 5.

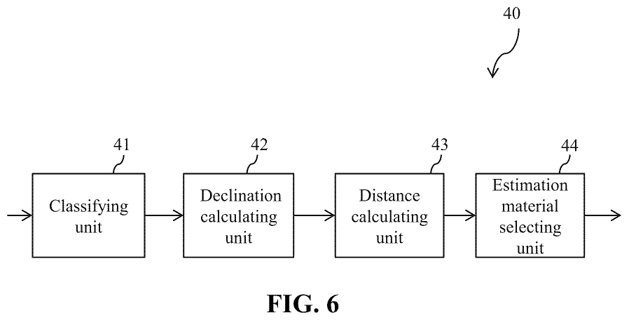

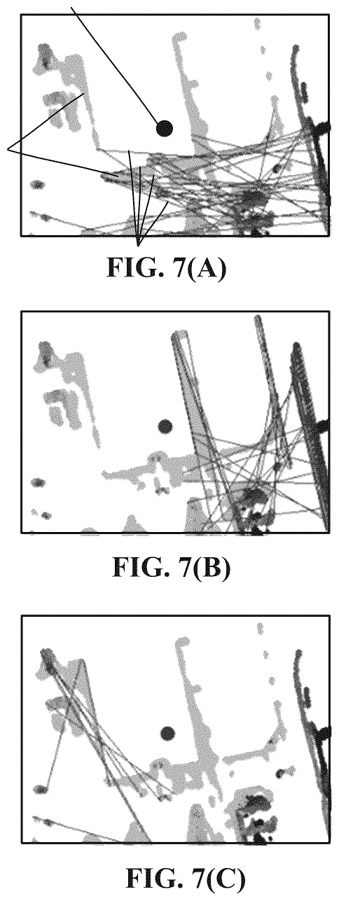

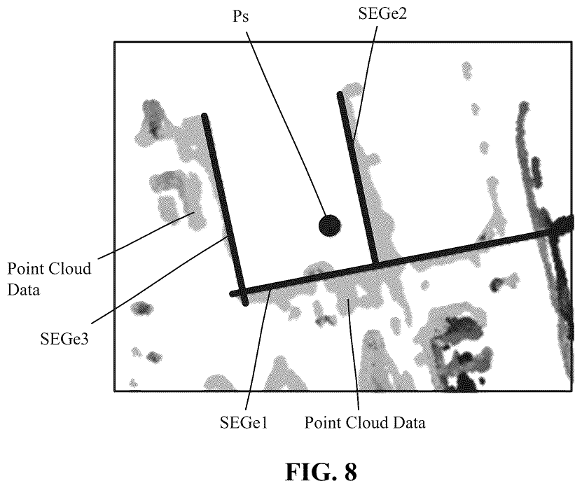

(Selection unit 40) FIG. 6 is a functional block diagram showing an example of the selecting unit according to an embodiment of the present invention. FIGS. 7(A), 7(B), and 7(C) illustrate the classifying concept of the plurality of candidate line segments. FIG. 8 shows the estimated line segment.

As shown in FIG. 6, the selecting unit 40 includes a classifying unit 41, a declination calculating unit 42, a distance calculating unit 43, and an estimation material selecting unit 44. The selecting unit 40 is realized by, for example, an arithmetic unit.

The classifying unit 41 classifies a plurality of candidate line segments SEGc into a plurality of different areas for the own ship based on the relationship between the heading (the direction in which the vector Lht in FIG. 7 extends) or the direction perpendicular to the heading (the direction in which the vector Llr in FIG. 7 extends) and the extending direction of the plurality of candidate line segments SEGc.

Specifically, the classifying unit 41 classifies the plurality of candidate line segments SEGc included in the area on the port side of the ship and the area on the starboard side of the ship using the cross product (which is also referred to as an outer product) of the direction parallel to the heading and the extending direction of the plurality of candidate line segments SEGc. Here, the cross product of the direction parallel to the heading and the extending direction of the plurality of candidate line segments SEGc is the cross product of the point at one end of the extending direction of the plurality of candidate line segments SEGc and the vector Lht parallel to the heading

For example, the classifying unit 41 sets two points on the candidate line segments SEGc to be classified. The two points are preferably as far apart as possible on the candidate line segments SEGc, for example, the points at both ends. The classifying unit 41 calculates the cross product of the two points on the candidate line segments SEGc and the vector Lht parallel to the heading, respectively.

The classifying unit 41 classifies the candidate line segments SEGc as a candidate line segment in the area on the port side of the ship if the results of the cross-product computation of the two points are both positive. The classifying unit 41 classifies the candidate line segment SEGc as a candidate line segment in the area on the port side of the ship if the results of the cross-product computation of the two points are both negative.

The classifying unit 41 excludes the candidate line segment SEGc from the classifying on the port and starboard side if the signs of the results of the cross-product computation of the two points are different. The classifying unit 41 may classify the excluded candidate line segment SEGc as a candidate line segment in the area on the bow side or the area on the stern side.

The classifying unit 41 classifies the plurality of candidate line segments SEGc included in the area on the bow side or the stern side of the ship by using the cross product of the direction perpendicular to the heading and the direction in which the plurality of candidate line segments SEGc extend. In this case, if the bow of the ship is on the far side (land side) of the jetty, the plurality of candidate line segments SEGc included in the area on the bow side are classified. On the other hand, if the stern of the ship is on the far side (land side) of the jetty, the plurality of candidate line segments SEGc included in the area on the stern side are classified. Here, the cross product of the direction perpendicular to the heading and the extending direction of the plurality of candidate line segments SEGc is the cross product of the point at one end of the extending direction of the candidate line segment SEGc and the vector Llr perpendicular to the heading.

By performing such processing, the classifying unit 41 classifies the candidate line segment SEGc included in the area on the bow side as shown in FIG. 7(A), the candidate line segment SEGc included in the area on the port side (when the bow is on the land side) as shown in FIG. 7(B), and the candidate line segment SEGc included in the area on the starboard side (when the bow is on the land side) as shown in FIG. 7(C).

In the area on the port side and the area on the starboard side, the declination calculating unit 42 calculates the declination of the candidate line segment SEG included in the area and the vector Lht parallel to the bow heading. In the area on the bow side (or the area on the stern side), the declination calculating unit 42 calculates the declination of the candidate line segment SEGc included in the area and the vector Llr perpendicular to the bow heading.

In the candidate line segment SEGc included in each area, the distance calculating unit 43 extracts the candidate line segment SEGc whose declination is equal to or less than the threshold. As a result, the candidate line segment SEGc that are approximately parallel to the heading are extracted for the port and starboard sides, and the candidate line segment SEGc that are approximately perpendicular to the heading are extracted for the bow (or stern) side.

The distance calculating unit 43 calculates the distance between the plurality of candidate line segments SEGc extracted based on the argument and the self-ship position.

The estimation material selecting unit 44 selects the plurality of candidate line segments SEGc with the shortest distance for each area and sets it as the estimated line segment. More specifically, for the area on the bow side (or the area on the stern side), the estimation material selecting unit 44 sets the candidate line segment SEGc with the declination less than or equal to the threshold and closest to the ship's position as the estimated line segment SEGe1 on the bow side. For the area on the port side, the estimation material selecting unit 44 sets the candidate line segment SEGc with the declination less than or equal to the threshold and closest to the ship's position as the estimated line segment SEGe2 on the port side. For the area on the starboard side, the estimation material selecting unit 44 sets the candidate line segment SEGc with the declination less than or equal to the threshold and closest to the ship's position as the estimated line SEGe3 on the starboard side.

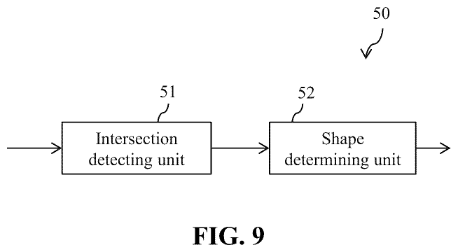

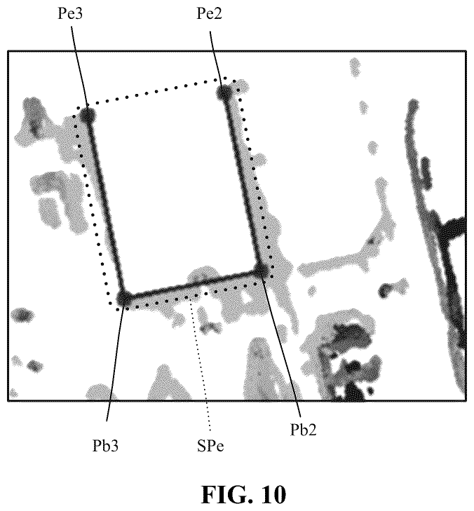

(Shape estimating unit 50) FIG. 9 is a functional block diagram showing an example of a shape estimating unit according to an embodiment of the present invention. FIG. 10 is a diagram explaining the shape estimation concept.

As shown in FIG. 9, the shape estimating unit 50 is realized by, for example, an arithmetic device. The shape estimating unit 50 includes an intersection detecting unit 51 and a shape determining unit 52.

The intersection detecting unit 51 detects the intersection Pb2 (position coordinates) of the estimated line SEGe1 on the bow side and the estimated line segment SEGe2 on the port side. The intersection detecting unit 51 detects the intersection Pb3 (position coordinates) of the estimated line segment SEGe1 on the bow side and the estimated line segment SEGe3 on the starboard side.

If the estimated line segment do not have an intersection with each other, the intersection point may be obtained by extending the estimated line segment.

The shape determining unit 52 detects a tip Pe2 (position coordinate) of the estimated line segment SEGe2 on the port side and a tip Pe3 (position coordinate) of the estimated line segment SEGe3 on the starboard side. The shape determining unit 52 determines the U-shape (a shape consisting of two parallel sides and a side approximately perpendicular to the two sides and connecting the two sides) by the positional coordinates of the intersection Pb2, the intersection Pb3, the tip Pe2, and the tip Pe3.

As described above, the navigation supporting device 10 may estimate the shape of a specific target (i.e., target) related to the navigation of a ship such as a quay or a pier.

At this time, the navigation supporting device 10 may estimate the shape of the target with high accuracy because it generates the plurality of candidate line segments for forming the shape of the target by means of highly accurate ranging results such as LiDAR and a linear detection technology.

In addition, the navigation supporting device 10 may suppress false positives and estimate the shape of the target with high accuracy by detecting the estimated line segment forming the shape of the target while dividing the plurality of candidate line segments into multiple areas according to the position of the ship. In this case, the navigation supporting device 10 may facilitate classifying and improve classifying accuracy by using the cross product.

In addition, the navigation supporting device 10 may detect estimated line segment with high accuracy by using the argument and the distance. In addition, the navigation supporting device 10 may detect estimated line segment with relatively simple arithmetic operations.

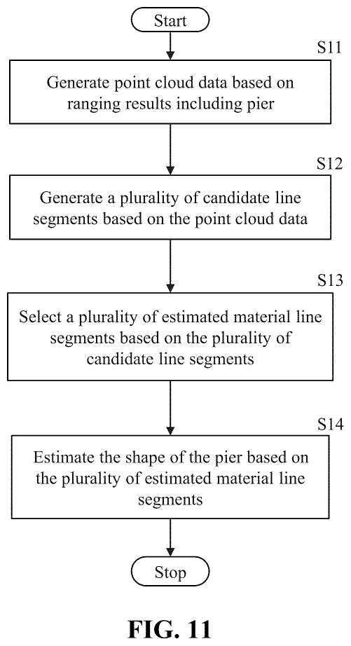

(Navigation supporting) FIG. 11 is a flow chart showing an example of navigation supporting device according to an embodiment of the present invention.

It should be noted that the specific details of each process in the flow chart shown in FIG. 11 have been described with the explanation of the configuration described above, so explanation will be omitted below except where necessary.

The navigation supporting device 10 generates the point cloud data based on the ranging results including the pier (S11). The navigation supporting device 10 generates the plurality of candidate line segments SEGc based on the point cloud data (S12).

The navigation supporting device 10 selects the plurality of estimated line segments SEGe1, SEGe2 and SEGe3 based on the plurality of candidate line segments SEGc (S13). The navigation supporting device 10 estimates the shape of the pier based on the plurality of estimated line segments SEGe1, SEGe2 and SEGe3 (S14).

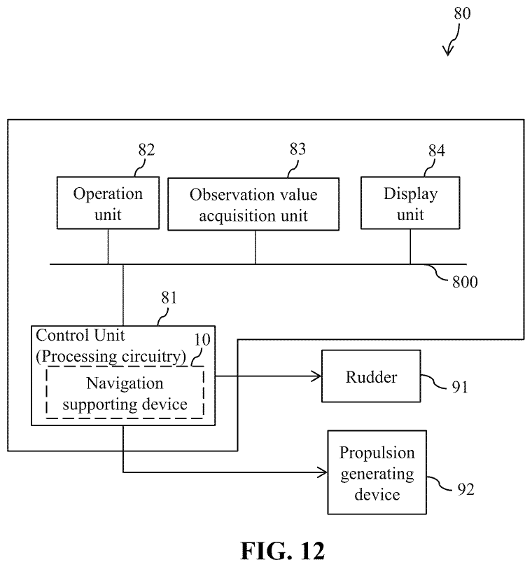

(Configuration of the navigation supporting system 80) FIG. 12 is a functional block diagram of the navigation supporting system according to an embodiment of the present invention. As shown in FIG. 12, the navigation supporting system 80 includes a control unit (processing circuitry) 81, an operation unit 82, an observation value acquisition unit 83, and a display unit 84. The navigation supporting system 80 is installed in the hull of a ship performing, for example, an autopilot control (automatic navigation control).

The control unit 81 is connected to the rudder 91 and the propulsion generating unit 92. The rudder 91 and the propulsion generating unit 92 are mounted on the hull. The control unit 81, the rudder 91 and the propulsion generating unit 92 are connected, for example, via analog voltage or data communication.

The control unit 81, the operation unit 82, the observation value acquisition unit 83, and the display unit 84 are connected to each other by, for example, a data communication network 800 for ships.

The operation unit 82 is realized by, for example, a touch panel, physical buttons or switches. The operation unit 82 accepts the operation of settings related to the autopilot control.

The observation value acquisition unit 83, realized by various sensors, acquires state data indicating the state of the ship such as its own position, the heading, a ship speed, a response angular speed, and a rudder angle.

The display unit 84, for example, is realized by a liquid crystal panel or the like. When information or the like related to the autopilot control is input from the control unit 81, for example, the display unit 84 displays the information. Although it is possible to omit the display unit 84, it is preferable to have it, and the presence of the display unit 84 allows the user to easily grasp the autopilot control status, etc.

The control unit 81 generates and stores the shape information of the pier obtained as described above. That is, the control unit 81 includes the configuration of the navigation supporting device 10 described above.

The control unit 81 performs autopilot control by a known method based on the operation input from the operation unit 82 and the state data from the observation value acquisition unit 83. The control unit 81 controls the steering angle of the rudder 91 and the propulsive force of the propulsion generating unit 92 by the autopilot control.

Upon receiving instructions for berthing operation from the operation unit 82, the control unit 81 acquires stored shape information of the pier. Based on the shape information of the pier and the position of the ship itself, the control unit 81 performs autopilot control so as to berth the ship to the pier.

More specifically, for example, the control unit 81 calculates the distance between the position of the ship and the shape information of the pier (location of the intersection Pb2, the intersection Pb3, the tip Pe2, and the tip Pe3). The control unit 81 calculates the direction from the position of the ship to the intersection Pb2, the intersection Pb3, the tip Pe2 and the tip Pe3. The control unit 81 performs rudder angle control and propulsion control based on the distances and directions, as well as the current ship speed, bow direction, motion characteristics of the ship, pier position and pier position.

In this case, the control unit 81 may display the predicted wake on the display unit 84 or may display pier support information to assist the helmsman in steering, not fully automatic.

With this, the navigation supporting system 80 may assist the ship in landing on the target pier or realize automatic pier landing. At this time, since the pier is estimated with high precision as described above, the navigation supporting system 80 may assist in landing with high precision or realize automatic pier landing with high precision.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately”, “about”, and “substantially” as used herein include the recited numbers, and also represent an amount close to the stated amount that still performs a desired function or achieves a desired result. For example, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A navigation supporting device, comprising:
processing circuitry configured to:
generate a plurality of candidate line segments for constituting a target based on point cloud data including a plurality of point clouds obtained by detecting surroundings of a ship;
select an estimated line segment constituting the target from the plurality of candidate line segments based on a positional relationship between the ship and the plurality of candidate line segments; and
estimate a shape of the target based on the estimated line segment.

2. The navigation supporting device of claim 1, wherein the processing circuitry is further configured to:
obtain a heading of the ship and select the estimated line segment based on the heading and an extending direction of the plurality of candidate line segments.

3. The navigation supporting device of claim 2, wherein the processing circuitry is further configured to:
select the estimated line segment based on an argument between the extending direction of the plurality of candidate line segments and the heading or a direction perpendicular to the heading.

4. The navigation supporting device of claim 2, wherein the processing circuitry is further configured to:
select the estimated line segment based on a distance between a position of the ship and the plurality of candidate line segments.

5. The navigation supporting device of claim 3, wherein the processing circuitry is further configured to:
classify the plurality of candidate line segments into a plurality of areas with respect to the position of the ship based on a relationship between the heading and the extending direction of the plurality of candidate line segments, and
select the estimated line segment for each of the plurality of areas.

6. The navigation supporting device of claim 5, wherein the processing circuitry is further configured to:
classify the plurality of candidate line segments based on a cross product of the heading and the extending direction of the plurality of candidate line segments.

7. The navigation supporting device of claim 5, wherein the processing circuitry is further configured to:
set the plurality of areas in at least a port side area or a starboard side area of the ship.

8. The navigation supporting device of claim 5, wherein the processing circuitry is further configured to:
classify the plurality of candidate line segments into the plurality of areas with respect to the position of the ship based on a relationship between the direction perpendicular to the heading and the extending direction of the plurality of candidate line segments.

9. The navigation supporting device of claim 8, wherein the processing circuitry is further configured to:
classify the plurality of candidate line segments based on a cross product of the direction perpendicular to the heading and the extending direction of the plurality of candidate line segments.

10. The navigation supporting device of claim 8, wherein the processing circuitry is further configured to:
set the plurality of areas to include at least an area on a bow side of the ship.

11. The navigation supporting device of claim 1, wherein the processing circuitry is further configured to:
estimate the shape of the target based on a connected state of the estimated line segment.

12. The navigation supporting device of claim 11, wherein the processing circuitry is further configured to:
estimate the shape of the target based on three estimated line segments perpendicular to each other as the connected state.

13. The navigation supporting device of claim 11, wherein the processing circuitry is further configured to:
estimate a shape having piers in three directions with reference to the position of the ship as the target.

14. The navigation supporting device of claim 1, wherein the processing circuitry is further configured to:
extract a linear component from two-dimensional point cloud data to generate the plurality of candidate line segments.

15. The navigation supporting device of claim 1, wherein the processing circuitry is further configured to:
perform three-dimensional ranging around the ship to generate three-dimensional point cloud data; and
project the three-dimensional point cloud data on a horizontal plane to generate two-dimensional point cloud data and output the two-dimensional point cloud data.

16. The navigation supporting device of claim 1, wherein the processing circuitry is further configured to:
perform an automatic maneuvering control to cause the ship to reach a specific position of the target based on the shape of the target.

17. The navigation supporting device of claim 3, wherein the processing circuitry is further configured to:
select the estimated line segment based on a distance between a position of the ship and the plurality of candidate line segments.

18. The navigation supporting device of claim 7, wherein the processing circuitry is further configured to:
classify the plurality of candidate line segments into the plurality of areas with respect to the position of the ship based on a relationship between the direction perpendicular to the heading and the extending direction of the plurality of candidate line segments.

19. A navigation supporting method, comprising:
generating a plurality of candidate line segments for constituting a target based on point cloud data including a plurality of point clouds obtained by detecting surroundings of a ship;
selecting an estimated line segment constituting the target from the plurality of candidate line segments based on a positional relationship between the ship and the plurality of candidate line segments; and
estimating a shape of the target based on the estimated line segment.

20. A non-transitory computer-readable medium having stored thereon computer-executable instructions which, when executed by a computer, cause the computer to:
generate a plurality of candidate line segments for constituting a target based on point cloud data including a plurality of point clouds obtained by detecting surroundings of a ship;
select an estimated line segment constituting the target from the plurality of candidate line segments based on a positional relationship between the ship and the plurality of candidate line segments; and
estimate a shape of the target based on the estimated line segment.
